(19) United States
(12) Patent Application Publication
(10) Pub. No.: US 2025/0353573 A1
(43) Pub. Date: Nov. 20, 2025

(54) Method for Operating a Drive Unit of an Electric Bicycle

(71) Applicant: Robert Bosch GmbH, Stuttgart (DE)

(72) Inventors: Matthias Weinmann, Balingen (DE); David Gabriel, Walddorfhaeslach (DE)

(21) Appl. No.: 19/207,592

(22) Filed: May 14, 2025

(30) Foreign Application Priority Data
May 15, 2024 (DE) 10 2024 204 515.2

(51) Int. Cl. B62M 6/50; B62J 45/413; F16D 41/24

(52) U.S. Cl. CPC B62M 6/50; B62J 45/413; F16D 41/24

(57) ABSTRACT

A method for operating a drive unit of an electric bicycle is disclosed. The drive unit includes a motor, an output element and a bidirectional freewheel between the motor and the output element. The method includes (i) determining a non-output state in which the output element is in a state of being substantially free of output torque, and (ii) controlling actuation of the motor during the non-output state for closing the bidirectional freewheel into a blocked state.

This application claims priority under 35 U.S.C. § 119 to application no. DE 10 2024 204 515.2, filed on May 15, 2024 in Germany, the disclosure of which is incorporated herein by reference in its entirety

### BACKGROUND

The present disclosure relates to a method for operating a drive unit for an electric bicycle, as well as to an electric bicycle.

In vehicles, such as electric bikes, freewheels are known to date, which are configured so as to interrupt a connection between a driven element shaft and a motor, if the driven element runs faster than an output of the motor with respect to the forward direction of rotation, i.e. in the direction of rotation that causes the vehicle to be driven in the forward direction of travel. Often, freewheels can only open in a relative direction of rotation. However, bidirectional freewheels are also known, which can open in both relative directions of rotation. Such a bidirectional freewheel is disclosed, for example, in DE 10 2023 201702 A1.

### SUMMARY

The method according to the disclosure, having the features set forth below, is characterized in that a special operation of the drive unit can be ensured in a particularly simple and reliable manner such that a bidirectional freewheel is closed in the powertrain, i.e. in the blocked state. According to the present disclosure, this is achieved by a method for operating a drive unit of an electric bicycle, wherein the drive unit comprises a motor and an output element and a bidirectional freewheel. The bidirectional freewheel is arranged between the motor and the output element, in particular with regard to a torque transfer. The method comprises the steps of:
determination of a non-output state in which the output element is in a state of being substantially free of output torque, and
controlled actuation of the motor during the non-output state for closing the bidirectional freewheel into a blocked state.

In particular, an element, such as a shaft and/or gear or the like, can be considered an output element of the drive unit, at which an output torque of the drive unit can be provided. By way of the output torque, preferably via a further powertrain of the vehicle, for example via a chainring with a chain, the propulsion of the electric bicycle can occur.

Preferably, the output element can be driven by a motor torque of the motor, as well as additionally by a pedal torque of a driver of the electric bicycle. For example, a control gear can be arranged between the motor and the output element, wherein the bidirectional freewheel is preferably arranged between the control gear and the output element. For example, a crank mechanism with cranks at which the driver can generate the pedal torque can be directly connected to the output element in a torque-transmitting manner. Alternatively, preferably, the crank mechanism can be indirectly connected to the output element, for example, wherein a further freewheel can be arranged between the output element and the crank mechanism.

The bidirectional freewheel is a freewheel which can lock and release with respect to both directions of rotation. Preferably, this can occur by way of mechanical actuation of the freewheel. Preferably, the bidirectional freewheel is substantially configured as a clamp roller freewheel, in particular having a freewheel cage and a preferably mechanical actuation mechanism, wherein the freewheel mechanism and the freewheel cage can be used in particular to lock and release the freewheel.

A non-output state is one in which substantially no output torque is provided at the output element, in particular which can generate torque on the powertrain of the electric bicycle. That is to say, in the non-output state, substantially no motor torque is generated by the motor and/or substantially no pedal torque by the driver of the electric bicycle is present. Preferably, the determination of the non-output state can be carried out by a control unit, for example, in a sensor-based manner and/or based on the operation of the motor.

In particular, the controlled actuation of the motor during the non-output state occurs in order to generate a movement of the motor, in particular an output shaft of the motor, in a targeted manner.

In other words, in the method, an active controlled actuation of the motor occurs in a state in which no output from the drive unit of the electric bicycle occurs. This in particular initiates a rotational movement in the bidirectional freewheel, which causes the freewheel to be reliably set into the blocked state, that is to say, to be blocked, and thus to subsequently allow a torque transmission from the motor towards the output element. That is to say, the bidirectional freewheel is clamped in a targeted manner by, for example, a short-term operation of the motor in order to achieve the blocked state.

The method thus offers the advantage that a reliable blocking of the freewheel can be provided in a particularly simple manner. In particular, the method can be carried out purely in a software-based manner, for example, without additional mechanical components. In addition, the method can be carried out particularly flexibly during operation of the electric bicycle, for example before or after certain driving situations, or in particular pushing situations. The method can thus ensure in a particularly simple and reliable manner that the freewheel is reliably blocked, for example for subsequent operating situations. As a result, it can be possible to immediately subsequently transfer a motor torque from the motor directly to the output element. In particular, this can help to avoid situations where a drive torque is to be produced by the motor, but torque transmission fails due to an opened bidirectional freewheel.

Preferred further modifications of the disclosure are set forth below.

Preferably, the controlled actuation of the motor occurs such that the motor rotates in the forward direction of rotation. In particular, the forward direction of rotation is a motor torque-generating rotational direction of the motor. That is to say, the motor is actuated so as to generate a motor torque suitable for propelling the electric bicycle. As a result, the freewheel can be particularly advantageously blocked such that a propulsion-effective motor torque can be provided by the motor directly thereafter.

Particularly preferably, the method further comprises the following step: detection of the blocked state of the bidirectional freewheel, in particular by way of a control unit. For example, the control unit can be part of the drive unit and/or the electric bicycle. That is to say, in the method, the state of the bidirectional freewheel being blocked is detected in a targeted manner. Preferably, the detection of the blocked state can be sensor-based. By additional explicit detection of the blocked state, further functions or operating states of the electric bicycle can be carried out, for example, simply and reliably as a function of the blocked state.

Preferably, the detection of the blocked state of the bidirectional freewheel occurs in response to a detection of a slope-holding state of the electric bicycle. In the slope-holding state, a predetermined minimum motor torque of the motor is required in order to maintain or achieve a motor speed of substantially equal to zero. In particular, the electric bicycle is in the slope-holding state on a slope, wherein the electric bicycle is held on the slope by the motor torque generated by the motor. In other words, it is thus detected that, for holding the electric bicycle at a standstill on a slope, a certain minimum motor torque must be generated by the motor in order to keep the motor speed substantially at zero, that is to say, in particular, to cause no propulsion and to not allow the electric bicycle to roll backwards. Specifically, a minimum motor torque of at least five Newton meters is considered to be the minimum motor torque. As a result, it can be easily and particularly reliably detected that the freewheel is in the blocked state.

Further preferably, the detection of the blocked state of the bidirectional freewheel occurs in response to a detection of a rotation of the motor in the reverse direction of rotation. That is to say, when the motor rotates in the reverse direction of rotation, which is in particular counter to the forward direction of rotation, it is assumed that the bidirectional freewheel is in the blocked state. In particular, this detection is based on the assumption that the rotation of the motor in the reverse direction is only possible when the bidirectional freewheel is closed and when a reverse rotation occurs starting from the output element, and in particular starting from the powertrain of the electric bicycle, for example when the bicycle is moved backwards counter to the direction of travel. The closed bidirectional freewheel can thus be reliably detected in a particularly simple manner. For example, the rotation of the motor in a reverse direction of rotation can be accomplished by way of a sensor and/or based on a generator current generated by the motor by way of the reverse rotation.

Preferably, the detection of the blocked state of the bidirectional freewheel occurs in response to a detection of a predetermined minimum motor load of the motor. In particular, the minimum motor load is a predetermined value for a determined current motor load of the motor. The motor load preferably corresponds to a current power output that the motor is required to apply. For example, the motor load can be determined based on an instantaneous motor torque of the motor. Alternatively or additionally preferably, the motor load can be a motor load that the motor must provide to the output element. In other words, the blocked state of the bidirectional freewheel is detected when the motor must apply a predetermined minimum motor load, which can in particular only be generated when the freewheel is closed. As a result, the blocked state of the bidirectional freewheel can be reliably detected in a further alternative and simple manner.

Particularly preferably, the controlled actuation of the motor during the non-output state is carried out until the blocked state of the bidirectional freewheel is detected. For example, the actuation of the motor can be carried out continuously until the blocked state is detected, or alternatively, the actuation of the motor can be carried out several times in a row until the blocked state is detected. The closed freewheel can thereby be ensured in a particularly reliable manner.

Preferably, the controlled actuation of the motor occurs continuously during the non-output state for a predetermined period of time. That is to say, the motor is rotated permanently during this predetermined period of time. For example, the time period can be predefined. That is to say, when carrying out the method, the motor can always be rotated for the predetermined period of time. For example, the period of time is a maximum of 1 second, preferably a maximum of 0.5 seconds, in particular at least 0.1 seconds. As a result, it possible to implement the method in a particularly straightforward and inexpensive manner.

Further preferably, the controlled actuation of the motor during the non-output state occurs in order to rotate the motor by a predetermined angle of rotation. That is to say, the motor is rotated by a predetermined distance. For example, the predetermined angle of rotation can be at least 1 degree, preferably a maximum of 3 degrees. Preferably, the predetermined rotation of the motor about the rotation angle is monitored by way of an angle sensor of the motor. The execution of the method can thus be particularly simple and efficient.

Particularly preferably, the controlled actuation of the motor during the non-output state comprises multiple rotations, in particular pulsations, of the motor. In particular, a pulsating rotation is a rotation of the motor carried out several times in succession for a short period of time. Preferably, the motor is rotated briefly for a predetermined number of time, respectively, within a certain period of time. In particular, a significant torque gradient is generated several times in a row by the motor on the bidirectional freewheel, which can ensure in a particularly reliable manner that the freewheel is or remains closed. Thus, the closed freewheel can be ensured particularly efficiently and reliably by way of the method.

Particularly preferably, the method is carried out during a slope-holding operation of the electric bicycle. The slope-holding operation is in particular when the electric bicycle is held on a slope by a motor torque generated by the motor, in particular so as to avoid rolling backwards. In particular, during the slope-holding operation, a motor torque is actively generated by operating the motor in order to keep the bicycle on the slope. Particularly preferably, the method for closing the freewheel is carried out by the motor directly prior to the slope-holding operation. Due to the fact that it can be reliably ensured with the method that the bidirectional freewheel is closed, it can thus be avoided that the electric bicycle undesirably rolls back in the slope-holding operation due to an unintentionally opened freewheel, because there is no torque-transmitting connection between the motor and the output element when the freewheel is open.

Preferably, the slope-holding operation is carried out in response to an assist signal generated manually by the driver of the electric bicycle. The assist signal can be generated by the driver by way of an input unit of the electric bicycle. For example, the input unit can comprise a button, or the like. In particular, the slope-holding operation and the assist signal can be part of a pushing aid of the electric bicycle. In particular, the pushing aid can comprise a controlled operation of the motor, which can be carried out in response to the assist signal without simultaneous pedaling by the driver. Thus, a particularly comfortable operation of the electric bicycle for the driver of the electric bicycle can be enabled.

Preferably, in the slope-holding operation, the electric bicycle is held at a slope by maintaining a motor speed of the motor at substantially zero by controlled generation of a motor torque by way of the motor. That is to stay, in the slope-holding operation, the motor is controlled by generating a motor torque down to a zero speed in order to thereby hold the electric bicycle at the slope while at a standstill.

Further preferably, the slope-holding operation is deactivated when the motor is operated load-free, in particular at least substantially, for at least a predetermined period of time. In particular, a load-free state of the motor is one in which the motor does not generate motor torque. For example, such a load-free state can exist when the driver of the electric bicycle actuates the brakes and thereby keeps the electric bicycle at a standstill by way of the brakes. In this case, after a predetermined period of time, actuation of the motor is no longer provided, so that the slope-holding operation can be ended.

Furthermore, the disclosure results in an electric bicycle comprising a drive unit having a motor and an output element and a bidirectional freewheel between the motor and the output element. In addition, the control unit is configured so as to carry out the described method.

### BRIEF DESCRIPTION OF THE DRAWINGS

An exemplary embodiment of the disclosure is explained in detail below with reference to the accompanying drawings. The drawing shows:

FIG. 1 a simplified schematic view of an electric bicycle in which a method to operate a drive unit of the electric bicycle according to a preferred exemplary embodiment of the disclosure is carried out,

FIG. 2 a highly simplified schematic view of a bidirectional freewheel of the electric bicycle of FIG. 1, and

FIG. 3 is a highly simplified schematic view of the method according to the disclosure.

### DETAILED DESCRIPTION

Preferably, all identical components, elements, and/or units are provided with the same reference symbols in all figures.

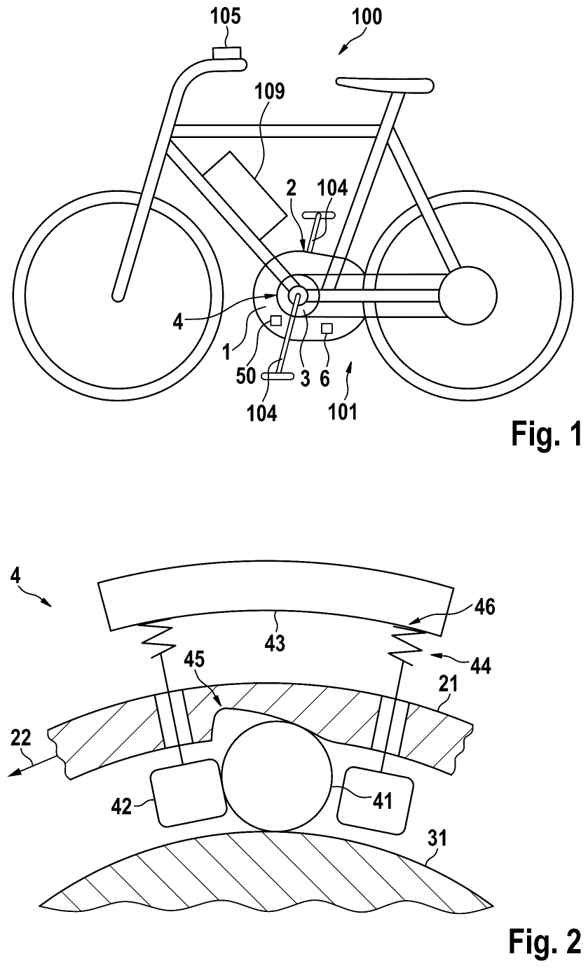

FIG. 1 shows a simplified schematic view of an electric bicycle 100 in which a method 10 to operate a drive unit 1 of the electric bicycle 100 according to a preferred exemplary embodiment of the disclosure is carried out.

The drive unit 1 comprises a motor 2, which is in particular an electric motor. The motor 2 can be supplied with electrical energy by way of an electrical energy store of the electric bicycle 100. The drive unit 1 is arranged in the region of a bottom bracket of the electric bicycle 100. A motor torque generated by the motor 2 can be used to provide motorized support for the pedal force generated by the muscle power of a rider of the electric bicycle 100. The muscle power of the rider can be applied via a crank mechanism with crank levers 104.

The drive unit 1 further comprises a control unit 50, which is configured so as to actuate the motor 2 in a controlled manner. For example, the control unit 50 can control an electrical actuation current for actuating the motor 2. In addition, the drive unit 1 comprises an output element 3 and a bidirectional freewheel 4.

The output element 3 in the illustrated exemplary embodiment is a chainring, which is part of a powertrain 101 of the electric bicycle 100 and at which all of the torque of the drive unit 1 can be transmitted to a rear wheel of the electric bicycle 100 via a bicycle chain. In detail, the motor torque and additionally the pedal torque of the driver can be provided on the output element 3.

Preferably, the output element 3 can be connected directly on the crank mechanism in a rotation-proof manner. Alternatively, for example, a further freewheel can be arranged between the crank mechanism and the output element 3.

The bidirectional freewheel 4 is arranged between the motor 2 and the output element 3 with respect to torque transmission. The freewheel drive 4 can, for example, be arranged directly adjacent to the motor 2. Alternatively, further elements, such as in particular a motor control gear, can be located between the motor 2 and the freewheel 4. Further preferably, the freewheel 4 and the output element 3 can be arranged directly adjacent to one another, or alternatively can be indirectly connected to one another via further elements.

The bidirectional freewheel 4 can cause a torque transfer between the motor 2 and the output element in a blocked state. In a freewheel state, the freewheel 4 prevents the torque transfer between the motor 2 and the output element 3.

Due to the fact that the freewheel 4 is configured in a bidirectional manner, the freewheel 4 can provide the freewheel state in both relative directions of rotation.

The functionality of the bidirectional freewheel 4 is explained in the following in a simplified manner, with the aid of FIG. 2. FIG. 2 shows a highly simplified schematic detail view of the bidirectional freewheel 4 of the electric bicycle 100 of FIG. 1.

The freewheel 4 comprises a motor-side first freewheel element 21, which is connected to the motor 2 in particular in a torque-transmitting manner. In addition, the freewheel 4 comprises an output-side second freewheel element 31, which is connected to the output element 3 in a torque-transmitting manner.

The freewheel 4 is substantially configured as a clamp roller freewheel and comprises a plurality of clamp rollers 41, which are arranged between the freewheel elements 21, 31. On the radially outer first freewheel element 21, a respective clamping geometry 45 is arranged per clamp roller 41. By way of the clamping geometries 45 and the clamp rollers 41, the blocked state or the freewheel state of the freewheel 4 can be enabled by clamping or releasing the clamp rollers 41 between the freewheel elements 21, 31. This can preferably be done by selective actuation of a freewheel cage 42 of the freewheel 4.

The freewheel cage 42 is arranged in the region of the clamp rollers 41 and can move or hold the clamp rollers 41 in place. Spring elements 44 connected to a fixed housing 43 of the drive unit 1 via a friction lock 46 can be used so as to cause a movement of the freewheel cage 42 in the event of a corresponding relative rotation in order to selectively actuate the clamp rollers 41, for example to hold them relative to the housing 43 or to release them from a clamped state.

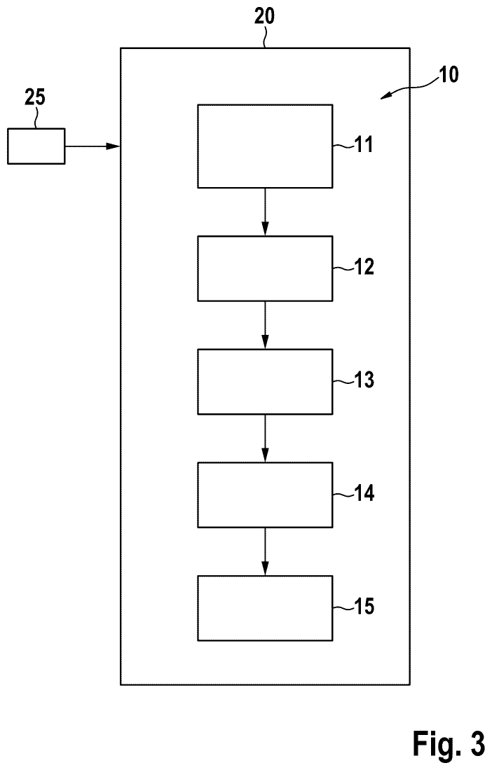

When operating the electric bicycle 100, it can occur that the bidirectional freewheel 4 is in the freewheel state, whereas the blocked state would be advantageous or desirable. In order to selectively set the freewheel 4 into the blocked state, the method 10 according to the disclosure is provided for operating the drive unit 1, which is described below with respect to FIGS. 2 and 3.

The method 10 is preferably carried out during a slope-holding operation 20 of the electric bicycle 100. The slope-holding operation 20 can be triggered by a manual actuation of the driver of the electric bicycle 100 in that the driver generates an assist signal 25 by way of an input unit 105 of the electric bicycle 100 (cf. FIG. 1).

If the electric bicycle 100 is on a slope, which can preferably be determined in a sensor-based manner, and if, for example, there is additionally no provision of propulsion for the electric bicycle 100, but rather a standstill, a motor torque can be generated by selectively operating the motor 2 by way of which the electric bicycle 100 is kept at a standstill on the slope. This slope-holding by way of the motor torque is only possible when the bidirectional freewheel 4 is closed, that is to say, in the blocked state. To securely provide the blocked state of the freewheel 4, the steps of the method 10 as described below are carried out.

In the method 10, it is first determined 11 whether a non-output state is present. In the non-output state, the output element 3 is in a state of being substantially free of output torque. That is to say, there is precisely no transmission of an output torque to the powertrain 101 of the electric bicycle 100 via the output element 3.

When the non-output state is present, then a controlled actuation 12 of the motor 2 occurs during the non-output state. The motor 2 is rotated in a forward direction of rotation in a targeted manner. As a result, the first freewheel element 21 is rotated relative to the second freewheel element 31 on the bidirectional freewheel 4, as indicated in FIG. 2 by the arrow 22. This causes the clamp rollers 41 to be clamped, and thus the freewheel 4 is set into the blocked state.

The controlled actuation of the motor 2 can occur in different ways. Particularly preferably, the motor 2 is moved in multiple pulsations, that is to say, it is moved in the forward direction of rotation several times in succession, for a short moment each time, within a predetermined period of time. This can particularly reliably ensure the clamping of the clamp rollers 41.

Advantageously, the controlled actuation 12 of the motor 2 occurs such that no significant propulsion of the electric bicycle 100 is caused. That is to say, any movement of the motor 2 is carried out by a low amount, which does not cause a significant forward movement of the electric bicycle 100.

Subsequently, in the method, a detection 14 of the blocked state 13 of the bidirectional freewheel 4 can occur. In particular, the detection 14 of the blocked state 13 can occur in response to a detection of a slope-holding state. In the slope-holding state, the motor 2 must generate a predetermined minimum motor torque in order to maintain a motor speed of substantially equal to zero. That is to say, keeping the electric wheel 100 at a standstill is possible on the slope by generating the motor torque when the freewheel 4 is closed. Alternatively or additionally preferably, the detection 14 of the blocked state 13 of the bidirectional freewheel 4 can occur in response to a direct detection of a predetermined minimum motor load. For example, the minimum motor load can be estimated based on a determined motor torque and/or motor speed.

In response to the detection 14 of the blocked state 13, the actual slope-holding operation 15 of the drive unit 1 can be carried out in the method 10. A motor torque is generated in a targeted manner by a controlled operation of the motor 2 by way of which the electric bicycle 100 is kept on the slope at a standstill. Preferably, the control unit 50 operates the motor 2 in a controlled manner down to a motor speed of zero. As a result, the driver of the electric bicycle 100 can be motor-assisted in holding the electric bicycle 100 on the slope in a simple and reliable manner.

The method 10 can be used in order to ensure, in a particularly reliable and simple and automatic manner, that the slope-holding operation is possible at any time. Through the targeted operation of the motor 2 during the non-output state, the bidirectional freewheel 4 is always reliably closed or kept closed in order to be able to directly transmit the motor torque generated by the motor 2 to the powertrain 101. Thus, in a simple and reliable manner, situations can be avoided in which, for example due to an opened freewheel 4 on the slope, the electric bicycle 100 may roll backwards.

What is claimed is:

1. A method for operating a drive unit of an electric bicycle, wherein the drive unit includes a motor, an output element and a bidirectional freewheel between the motor and the output element, the method comprising:
determining a non-output state in which the output element is in a state of being substantially free of output torque, and
controlling actuation of the motor during the non-output state for closing the bidirectional freewheel into a blocked state.

2. The method according to claim 1, wherein the controlling actuation of the motor occurs such that the motor rotates in the forward direction of rotation.

3. The method according to claim 1, further comprising:
detecting the blocked state of the bidirectional freewheel by way of a control unit.

4. The method according to claim 3, wherein:
the detecting the blocked state of the bidirectional freewheel occurs in response to a detection of a slope-holding state, and
in the slope-holding state, a predetermined minimum motor torque of the motor is required in order to maintain or achieve a motor speed of substantially equal to zero.

5. The method according to claim 3, wherein the detecting the blocked state of the bidirectional freewheel occurs in response to a detection of a rotation of the motor in the reverse direction of rotation.

6. The method according to claim 3, wherein the detecting the blocked state of the bidirectional freewheel occurs in response to a detection of a predetermined minimum motor load.

7. The method according to claim 3, wherein the controlling actuation of the motor during the non-output state is carried out until the blocked state of the bidirectional freewheel has been detected.

8. The method according to claim 1, wherein the controlling actuation of the motor occurs continuously during the non-output state for a predetermined period of time.

9. The method according to claim 1, wherein the controlling actuation of the motor during the non-output state occurs so as to rotate the motor by a predetermined angle of rotation.

10. The method according to claim 1, wherein the controlling actuation of the motor during the non-output state comprises multiple rotations of the motor.

11. The method according to claim 1, wherein the method is carried out during a slope-holding operation of the electric bicycle.

12. The method according to claim 11, wherein the slope-holding operation is carried out in response to a manually generated assist signal by a driver of the electric bicycle via an input unit of the electric bicycle.

13. The method according to claim 11, wherein:
in the slope-holding operation, the electric bicycle is held at a slope by maintaining a motor speed of substantially zero by controlled generation of a motor torque by way of the motor.

14. The method according to claim 11, wherein the slope-holding operation is deactivated when the motor is operated load-free for at least a predetermined period of time.

15. An electric bicycle, comprising:
a drive unit having a motor, an output element and a bidirectional freewheel between the motor and output element; and
a control unit configured so as to carry out the method according to claim 1.

16. The method according to claim 1, wherein the controlling actuation of the motor during the non-output state comprises multiple pulsations of the motor.
